(19) United States
(12) Patent Application Publication
(10) Pub. No.: US 2026/0122085 A1
(43) Pub. Date: Apr. 30, 2026

(54) MULTILAYER DECISIONING STRUCTURE FOR ENHANCED NETWORK SECURITY

(71) Applicant: BANK OF AMERICA CORPORATION, Charlotte, NC (US)

(72) Inventors: Carl R. Frederick, Lexington, OH (US); Mohammad Azad, Huntersville, NC (US); Angelica Espino, Panorama City, CA (US); Blayne S. Gower, Midlothian, VA (US)

(73) Assignee: BANK OF AMERICA CORPORATION, Charlotte, NC (US)

(21) Appl. No.: 18/925,700

(22) Filed: Oct. 24, 2024

(51) Int. Cl. H04L 9/40

(52) U.S. Cl. CPC H04L 63/1425

(57) ABSTRACT

Embodiments of the invention are directed to systems, methods, and computer program products for automatically enabling features in a software production environment. In some embodiments, the method includes monitoring a network traffic log of a network; detecting, using a first machine learning model, a triggering event, wherein at least one input of the first machine learning model comprises the monitored network traffic log; establishing a remote connection with a user device; and causing the user device to launch an event resolution protocol. The method may also include retrieving an unstructured dataset from the user device; and transforming the unstructured dataset into a structured dataset using a generative artificial intelligence (AI) model, wherein at least one input of the first machine learning model comprises the structured dataset.

### FIELD OF THE INVENTION

The present invention embraces a system for enhancing network security through a multilayer decisioning structure.

### BACKGROUND

There is a need for a system that allows for secure data gathering from third party devices while maintaining a level of abstraction from the hardware of the devices.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for enhancing network security through a multilayer decisioning structure, the invention including: monitoring a network traffic log of a network; detecting, using a first machine learning model, a triggering event, where at least one input of the first machine learning model includes the monitored network traffic log; establishing a remote connection with a user device; and causing the user device to launch an event resolution protocol.

In some embodiments, the invention further includes retrieving an unstructured dataset from the user device and transforming the unstructured dataset into a structured dataset using a generative artificial intelligence (AI) model.

In some embodiments, transforming the unstructured dataset into a structured dataset further includes storing the unstructured dataset in a batch data warehouse of the generative AI model and transferring the unstructured dataset from the batch data warehouse of the generative AI model to a pre-processing engine of the generative AI model.

In some embodiments, at least one input of the first machine learning model includes the structured dataset.

In some embodiments, the event resolution protocol includes updating a network permission status of the user device and receiving at least one command from the user device.

In some embodiments, the event resolution protocol further includes causing the user device to access the network via a virtual machine and receiving one or more inputs through the virtual machine.

In some embodiments, wherein the triggering event is associated with a first user of the network, and wherein the first user is not a user of the user device.

In some embodiments, establishing the remote connection with the user device further includes identifying the user device based on geolocation data of a plurality of user devices, the plurality of user devices including the user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates technical components of a system for enhancing network security through a multilayer decisioning structure, in accordance with one embodiment of the present disclosure;

FIG. 2 is a block diagram illustrating the system for enhancing network security through a multilayer decisioning structure, in accordance with one embodiment of the present disclosure;

FIG. 3 illustrates an exemplary generative artificial intelligence (AI) subsystem, in accordance with one embodiment of the present disclosure; and

FIG. 4 illustrates a process flow for enhancing network security through a multilayer decisioning structure, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, an “entity” may be any institution employing information technology resources and particularly technology infrastructure configured for managing electronic workflows. Typically, these workflows can be related to the people who work for the organization, its products or services, the customers or any other aspect of the operations of the organization. As such, the entity may be any institution, group, association, financial institution, establishment, company, union, authority or the like, employing information technology resources for managing electronic workflows.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making a prediction about a dataset. Machine learning algorithms contemplated, described, and/or used herein include supervised learning (e.g., using logistic regression, using back propagation neural networks, using random forests, decision trees, and the like), unsupervised learning (e.g., using an Apriori algorithm, using K-means clustering), semi-supervised learning, reinforcement learning (e.g., using a Q-learning algorithm, using temporal difference learning), and/or any other suitable machine learning model types. Each of these types of machine learning algorithms can implement any of one or more of a regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, C4.5, chi-squared automatic interaction detection, decision stump, random forest, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, a linear analysis, and the like), a clustering method (e.g., k-means clustering, expectation maximization, and the like), an associated rule learning algorithm, an artificial neural network model (e.g., a Perceptron method, a back-propagation method, a Hopfield network method, a self-organizing map method, a learning vector quantization method, and the like), a deep learning algorithm (e.g., a deep belief network method, a convolution network method, a stacked auto-encoder method, and the like), a dimensionality reduction method (e.g., principal component analysis, partial least squares regression, multidimensional scaling, projection pursuit, and the like), an ensemble method (e.g., boosting, bootstrapped aggregation, stacked generalization, gradient boosting machine method, random forest method, and the like), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

The present invention provides a system and method for enhancing network security by delegating approval of certain unusual network activity to user devices that are isolated from said activity. Furthermore, the system provides for secure data gathering from the user devices by providing a virtual machine or an equivalent software platform that is abstracted from the hardware of the user device. In some embodiments, the system employs a generative artificial intelligence (AI) engine to transform the unstructured data received from the user devices into structured datasets which are ingestible by a machine learning model configured to identify patterns of unusual network activity.

For example, the present invention may provide a first layer of protection at an individual level, by assigning trusted account approvers or overseers to approve, review, or decline transactions meeting certain criteria (e.g., aggregate amount (total, percentage, difference from past, and/or the like), destination, category, and/or the like. Unlike conventional account overseer systems, the present invention does not require that an account approver be an account owner. In some examples, the system may enable a trusted account approver to action approvals or denials for one-time use or on a recurring basis. To do so, the system may provide a trusted account approver with options to enable specific rules or permissions as pre-approvals, auto-approvals, and/or the like. In some examples, an individual account may be associated with more than one trusted account approver. A trusted account approver may comprise an individual, group of individuals, organization, entity, or a particular device.

At the first layer of protection, the system may prompt a trusted account approver for additional guidance on a decision reason through a variety of data gathering techniques (i.e., category, freeform, AI-assisted, and/or the like). Data gathered in layers across general & specific types of network activity can be used to further guide structured & unstructured information gathering from system users to more precisely understand networks of suspicious activity.

In some examples, the present invention may provide a second layer of protection at an entity level, by leveraging data collected from the trusted account approvers or overseers with other data gathered on financial transactions to identify patterns across individuals and accounts, thereby to uncovering potential networks behind suspicious network activity. The second layer of protection may enable an entity system to more readily identify other transactions requiring additional levels of review. In some examples, analysis at this second layer triggers additional alerts or inquiries to system users & trusted account approvers to gather context data relevant to approving, pausing, and/or declining transactions to support further investigative inquiries.

In some examples, the present invention may additionally provide a third layer of protection across multiple entity systems to investigate suspicious transactions and to better identify a broader scope of potential suspicious activities. In some examples, the entity systems may comprise financial institutions.

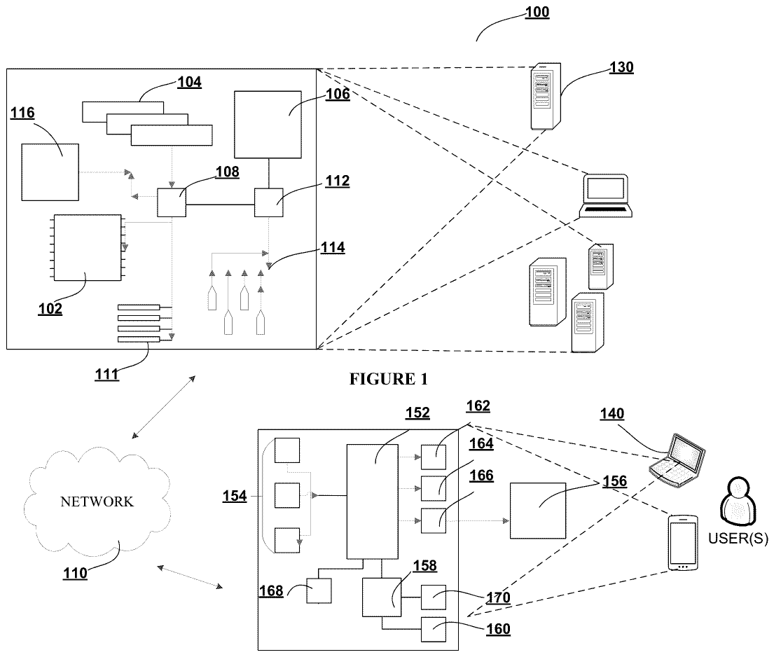

FIG. 1 presents an exemplary block diagram of a system environment 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is one or more user(s) of the user input system 140. The user input system 140 is intended to represent various forms of mobile devices, such as laptops, personal digital assistants, augmented reality (AR) devices, virtual reality (VR) devices, extended reality (XR) devices, and/or the like, and non-mobile devices such as desktops, video recorders, audio/video player, radio, workstations, and/or the like. The user may be a person who uses the user input system 140 to execute one or more processes described herein using one or more applications stored thereon. The one or more applications may be configured to communicate with the system 130, execute a process or method, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, electronic kiosk devices, blade servers, mainframes, or any combination of the aforementioned. The user input system 140 is intended to represent various forms of personal devices, such as laptops, desktops, mobile devices, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by an entity. The system 130 may be located at a facility associated with the entity or remotely from the facility associated with the entity.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

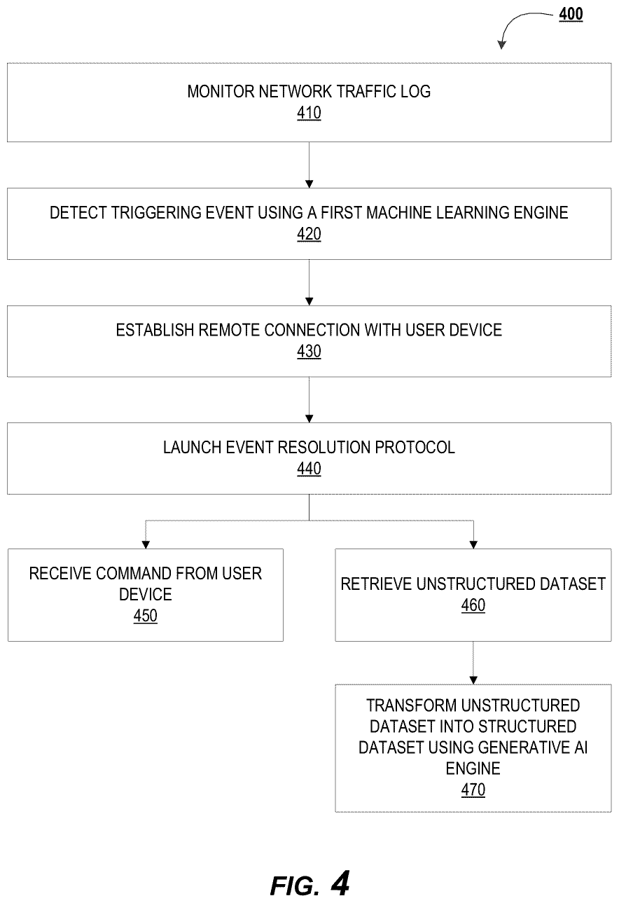

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flow discussed in greater detail with respect to FIG. 4. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation-and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

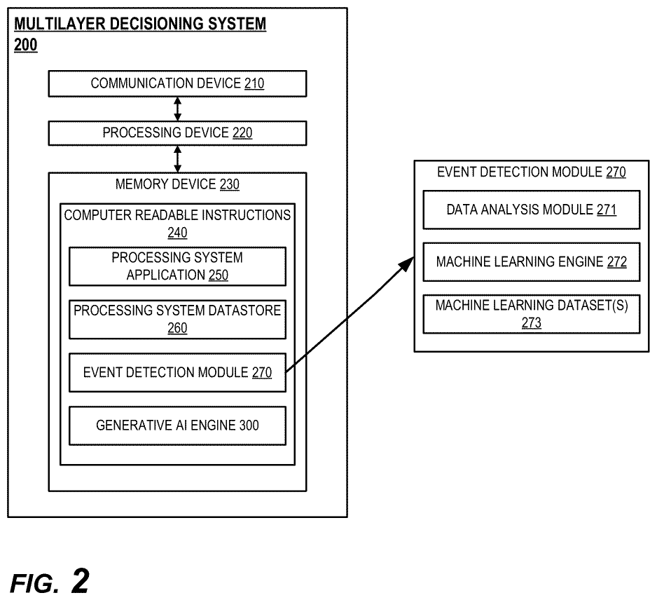

FIG. 2 illustrates a block diagram of a multilayer decisioning system 200 associated with the system environment 100, in accordance with embodiments of the present invention. As illustrated in FIG. 2, the multilayer decisioning system 200 may include a communication device 210, a processing device 220, and a memory device 230 having an event detection module 270, a generative AI engine 300, a processing system application 250 and a processing system datastore 260 stored therein. As shown, the processing device 220 is operatively connected to and is configured to control and cause the communication device 210 and the memory device 230 to perform one or more functions. In some embodiments, the generative AI engine 300, the event detection module 270 and/or the processing system application 250 comprise computer readable instructions 240 that when executed by the processing device 220 cause the processing device 220 to perform one or more functions and/or transmit control instructions to other systems, applications, and/or devices in the system environment 100. It will be understood that the generative AI engine 300, the event detection module 270 and/or the processing system application 250 may be executable to initiate, perform, complete, and/or facilitate one or more portions of any embodiments described and/or contemplated herein.

The event detection module 270 may further comprise a data analysis module 271, a machine learning engine 272, and a machine learning dataset(s) 273. The data analysis module 271 may store instructions and/or data that may cause or enable the multilayer decisioning system 200 to receive, store, and/or analyze data received from the generative AI engine 300 and/or the processing system datastore 260. The data analysis module may process data and/or metadata to continuously monitor one or more network traffic logs as is further discussed with respect to FIG. 4. The machine learning engine 272 and machine learning dataset(s) 273 may store instructions and/or data that cause or enable the multilayer decisioning system 200 to detect, in real-time and based on received information, one or more triggering events as is further discussed with respect to FIG. 4. The machine learning dataset(s) 273 may contain data queried from one or more remote severs and/or may be based on historical data relating to a particular data category, data type, or the like. In some embodiments, the machine learning dataset(s) 273 may also contain data relating to a plurality of machine learning algorithms.

The machine learning engine 272 may receive data from a plurality of sources and, using one or more machine learning algorithms, may generate one or more machine learning datasets 273. Various machine learning algorithms may be used without departing from the invention as is described in greater detail herein.

The machine learning datasets 273 may include machine learning data linking one or more outputs of the generative AI engine 300 with one or more outputs of the data analysis module 271 to preemptively detect triggering events occurring in the network. For example, the machine learning datasets 273 may include information linking network destination data (e.g. IP addresses, port numbers, and/or the like) with a higher likelihood of resulting in a triggering event. In another example, the machine learning datasets 273 may include historical network traffic information having a high degree of correlation with past events. The information contained in the machine learning datasets 273 may cause the event detection module 270 to determine that a particular pattern of network traffic data indicates the presence of a triggering event.

The communication device 210 may generally include a modem, server, transceiver, and/or other devices for communicating with other devices on the network 101. The communication device 210 may be a communication interface having one or more communication devices configured to communicate with one or more other devices on the network 101.

Additionally, referring to the multilayer decisioning system 200 illustrated in FIG. 2, the processing device 220 may generally refer to a device or combination of devices having circuitry used for implementing the communication and/or logic functions of the multilayer decisioning system 200. For example, the processing device 220 may include a control unit, a digital signal processor device, a microprocessor device, and various analog-to-digital converters, digital-to-analog converters, and other support circuits and/or combinations of the foregoing. Control and signal processing functions of the data obfuscation system 200 may be allocated between these processing devices according to their respective capabilities. The processing device 220 may further include functionality to operate one or more software programs based on computer-executable program code 240 thereof, which may be stored in a memory device 230, such as the processing system application 250 and the event detection module 270. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 230 within the multilayer decisioning system 200 may generally refer to a device or combination of devices that store one or more forms of computer-readable media for storing data and/or computer-executable program code/instructions. For example, the memory device 230 may include any computer memory that provides an actual or virtual space to temporarily or permanently store data and/or commands provided to the processing device 220 when it carries out its functions described herein. As used herein, memory may include any computer readable medium configured to store data, code, or other information. The memory device 350 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the multilayer decisioning system 200 performing one or more steps described herein in conjunction with other devices and systems, either automatically based on executing computer readable instructions of the memory device 230, or in response to receiving control instructions from another device in the system environment 100. In some instances, the system refers to the devices and systems on the system environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

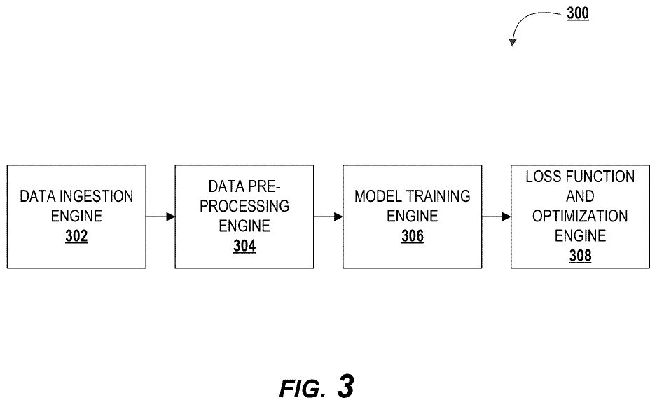

FIG. 3 illustrates an exemplary generative AI subsystem 300, in accordance with an embodiment of the invention. The generative AI subsystem 300 may include a data ingestion engine 302, a data pre-processing engine 304, a model training engine 306, and a loss function and optimization engine 308. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), or other generative models, depending on the specific requirements of the system. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

For VAEs, the model training engine 306 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In embodiments using GANs, the model training engine 306 may train two distinct but interconnected networks: the generator and the determinator. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the determinator network is tasked with differentiating between the real data—coming directly from the training set—and the synthetic data generated by the generator. The determinator acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum matrix. The generator continuously tries to improve its ability to generate convincing data, while the determinator simultaneously improves its capacity to distinguish between real and generated data. During each training iteration, the generator attempts to “fool” the determinator by creating more realistic data samples, while the determinator receives feedback to better catch fake data. This adversarial feedback loop leads both networks to improve their performance over time. The loss functions for both networks guide this competition: the generator's loss reflects how well it was able to fool the determinator, while the determinator's loss reflects how accurately it classified real versus generated data. Through this iterative, competitive process, the generator becomes increasingly skilled at producing highly realistic data samples that are difficult for the determinator to differentiate from real data. Eventually, the generator learns to generate synthetic data that is nearly indistinguishable from the real data.

The model training engine 306 may include a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The determinator is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

FIG. 4 is a high-level process flow diagram illustrating a process 400 using the multilayer decisioning system, in accordance with one embodiment of the present disclosure. The process begins at block 410, where the system is configured to continuously monitor one or more network traffic logs of a network. In some embodiments, the data analysis module 271 may monitor network traffic logs and feed the monitored data to the machine learning engine 272. The process may then continue to block 420, where the system is configured to detect a triggering event based on the network traffic log. As used herein, a triggering event may comprise any network activity meeting a set of predetermined criteria. For example, a triggering event may include activity such as a significant deviation from a pattern of past activity, activity involved one or more flagged origin or destination devices, and/or the like. In some embodiments, the machine learning engine 272 may be further trained to identify triggering events based on a training dataset generated by the generative AI engine 300 as is described in greater detail with respect to block 470.

The process may then continue to block 430, where the system is configured to establish a remote connection with a user device. In some embodiments, the triggering event may be associated with a first user of the network, and the system may identify the user device from a list of user devices associated with the user of the network, where each user device on the list is associated with a user other than the first user. For example, a triggering event may involve a personal computer of a first user. The system may then query the processing system datastore 260 for a list of associated user devices. The list of associated user devices may be prepopulated based on preferences of the first user. For example, the list of associated user devices may include the smartphone of a trusted second user, the smartphone of a trusted third user, and an entity device associated with a trusted third party entity. In some embodiments, the system may select the user device from the list based on geolocation data of the user devices. For example, the system may query the user devices for geolocation data, and may select the user device which is in closest proximity to first user of the network. Additionally or alternatively, the system may select the user device based on a predetermined ranking of the list.

The process may then continue to block 440, where the system is configured to cause the user device to launch an event resolution protocol. In some embodiments, causing the user device to launch an event resolution protocol may include amending a network permission of the user device. For example, the system may provide the user device access to network traffic information that would otherwise be unavailable to the user device.

In some embodiments, the process may then continue to block 450, where the system is configured to receive a command from the user device. For example, the system may receive a command to block or shut down certain network activity and/or may receive a command to allow the network activity. Additionally or alternatively, the system may receive a command to launch the event resolution protocol with another user device from the list.

Additionally or alternatively, in some embodiments, the process may continue from block 440 to block 460, where the system is configured to receive an unstructured dataset from the user device. In some embodiments, the system may cause the user device to access the network via a virtual machine or other similar protected experience, such that the user device may enter information, upload files, access webpages, and/or the like while keeping the hardware of the user device isolated from potential malware. The unstructured dataset received from the user device may include any file format or data type relevant to the triggering event.

The process may then continue to block 470, where the system is configured to transform the unstructured dataset into a structured dataset using a generative AI engine. The features and functions of the generative AI engine are described in greater detail with respect to FIG. 3. In general, the generative AI engine may transform the unstructured data received from the user device into a structured dataset which is ingestible by the machine learning engine 272. Thus, the machine learning engine 272 may be continuously trained using the structured dataset in order to further refine the system's ability to preemptively detect triggering events in the network.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for enhancing network security through a multilayer decisioning structure, the system comprising:
at least one non-transitory storage device; and
at least one processing device coupled to the at least one non-transitory storage device, wherein the at least one processing device is configured to:
monitor a network traffic log of a network;
detect, using a first machine learning model, a triggering event, wherein at least one input of the first machine learning model comprises the monitored network traffic log;
establish a remote connection with a user device; and
cause the user device to launch an event resolution protocol.

2. The system of claim 1, wherein the at least one processing device is further configured to:
retrieve an unstructured dataset from the user device; and
transform the unstructured dataset into a structured dataset using a generative artificial intelligence (AI) model.

3. The system of claim 2, wherein transforming the unstructured dataset into a structured dataset further comprises:
storing the unstructured dataset in a batch data warehouse of the generative AI model; and
transferring the unstructured dataset from the batch data warehouse of the generative AI model to a pre-processing engine of the generative AI model.

4. The system of claim 2, wherein at least one input of the first machine learning model comprises the structured dataset.

5. The system of claim 1, wherein the event resolution protocol comprises:
updating a network permission status of the user device; and
receiving at least one command from the user device.

6. The system of claim 5, wherein the event resolution protocol further comprises:
causing the user device to access the network via a virtual machine; and
receiving one or more inputs through the virtual machine.

7. The system of claim 1, wherein the triggering event is associated with a first user of the network, and wherein the first user is not a user of the user device.

8. The system of claim 1, wherein establishing the remote connection with the user device further comprises identifying the user device based on geolocation data of a plurality of user devices, the plurality of user devices comprising the user device.

9. A computer program product for enhancing network security through a multilayer decisioning structure, the computer program product comprising at least one non-transitory computer-readable medium having computer-readable program code portions embodied therein, the computer-readable program code portions comprising:
an executable portion configured for monitoring a network traffic log of a network;
an executable portion configured for detecting, using a first machine learning model, a triggering event, wherein at least one input of the first machine learning model comprises the monitored network traffic log;
an executable portion configured for establishing a remote connection with a user device; and
an executable portion configured for causing the user device to launch an event resolution protocol.

10. The computer program product of claim 9, further comprising:
an executable portion configured for retrieving an unstructured dataset from the user device; and
an executable portion configured for transforming the unstructured dataset into a structured dataset using a generative artificial intelligence (AI) model.

11. The computer program product of claim 10, wherein transforming the unstructured dataset into a structured dataset further comprises:
storing the unstructured dataset in a batch data warehouse of the generative AI model; and
transferring the unstructured dataset from the batch data warehouse of the generative AI model to a pre-processing engine of the generative AI model.

12. The computer program product of claim 10, wherein at least one input of the first machine learning model comprises the structured dataset.

13. The computer program product of claim 9, wherein the event resolution protocol comprises:
updating a network permission status of the user device; and
receiving at least one command from the user device.

14. The computer program product of claim 13, wherein the event resolution protocol further comprises:
causing the user device to access the network via a virtual machine; and
receiving one or more inputs through the virtual machine.

15. The computer program product of claim 9, wherein the triggering event is associated with a first user of the network, and wherein the first user is not a user of the user device.

16. The computer program product of claim 9, wherein establishing the remote connection with the user device further comprises identifying the user device based on geolocation data of a plurality of user devices, the plurality of user devices comprising the user device.

17. A computer-implemented method for enhancing network security through a multilayer decisioning structure, the method comprising:
providing a computing system comprising a computer processing device and a non-transitory computer readable medium, wherein the computer readable medium comprises configured computer program instruction code, such that when said instruction code is operated by said computer processing device, said computer processing device performs the following operations:
monitoring a network traffic log of a network;
detecting, using a first machine learning model, a triggering event, wherein at least one input of the first machine learning model comprises the monitored network traffic log;
establishing a remote connection with a user device; and
causing the user device to launch an event resolution protocol.

18. The method of claim 17, further comprising:
retrieving an unstructured dataset from the user device; and
transforming the unstructured dataset into a structured dataset using a generative artificial intelligence (AI) model, wherein at least one input of the first machine learning model comprises the structured dataset.

19. The method of claim 17, wherein the event resolution protocol comprises:
updating a network permission status of the user device; and
receiving at least one command from the user device.

20. The method of claim 17, wherein the triggering event is associated with a first user of the network, and wherein the first user is not a user of the user device.
